(19) United States
(12) Patent Application Publication
(10) Pub. No.: US 2019/0182313 A1
(43) Pub. Date: Jun. 13, 2019

(54) APPARATUS AND METHOD FOR PROCESSING BLOCKCHAIN TRANSACTION IN DISTRIBUTED MANNER

(71) Applicant: Electronics and Telecommunications Research Institute, Daejeon (KR)

(72) Inventors: Hyun Kyung YOO, Daejeon (KR); Jong Choul YIM, Daejeon (KR); Ji Young KWAK, Gwangju (KR); Sun Me KIM, Daejeon (KR); Thai Quang Tung, Daejeon (KR)

(73) Assignee: Electronics and Telecommunications Research Institute, Daejeon (KR)

(21) Appl. No.: 16/170,132

(22) Filed: Oct. 25, 2018

(30) Foreign Application Priority Data
Dec. 7, 2017 (KR) 10-2017-0167662

(51) Int. Cl. H04L 29/08

(52) U.S. Cl. CPC H04L 67/10

(57) ABSTRACT

A method for a node, which is positioned in a network including at least one shard based on regionally divided domains, to process a blockchain transaction in a distributed manner may comprises generating a dynamic committee including a plurality of nodes included in an identical shard; verifying a transaction through the generated committee and generating a transaction block; and storing the generated transaction block in a local ledger to which the node belongs. The at least one shard may include at least one local shard including nodes regionally positioned within a certain range and a global shard including a plurality of nodes belonging to different local shards.

### CLAIM FOR PRIORITY

This application claims priority to Korean Patent Application No. 2017-0167662 filed on Dec. 7, 2017 in the Korean Intellectual Property Office (KIPO), the entire contents of which are hereby incorporated by reference.

### BACKGROUND

### 1. Technical Field

Example embodiments of the present invention relate to an apparatus and method for processing a blockchain transaction in a distributed manner, and more specifically, to an apparatus and method for processing a blockchain in a distributed manner whereby shards are organized on the basis of regionally divided domains to simultaneously process a transaction.

### 2. Related Art

A blockchain is a distributed ledger in which information on transactions occurring in a network is encrypted and shared among nodes in the network. Transaction information of a blockchain does not depend on a centralized system but is rather verified and managed by nodes on the basis of a peer-to-peer (P2P) network.

Blockchain is a concept implemented by Bitcoin, which is the first cryptocurrency, and attracting attention. All cryptocurrencies have respective blockchains. There is no central bank that issues a cryptocurrency, but rather a cryptocurrency is generated as a reward for searching for a block at regular intervals. The block is composed of a hash function used by the corresponding cryptocurrency, and a user searches for a hash by attempting individual application of appropriate functions with computing power of a computer. Such a process is referred to as mining.

The blockchain technology does not require resources for running an official certificate authority and provides transparent transactions because all transaction records are encrypted and disclosed. However, distributed individual nodes are required to store the whole blockchain. Also, when transactions increase, network transmission is delayed to simultaneously process increased transactions, which thus increases the processing cost.

### SUMMARY

Accordingly, example embodiments of the present invention are provided to substantially obviate one or more problems due to limitations and disadvantages of the related art.

Example embodiments of the present invention provide a method of processing a blockchain transaction in a distributed manner using sharding based on regionally divided domains.

Example embodiments of the present invention also provide an apparatus for processing a blockchain transaction in a distributed manner using the method of processing a blockchain transaction.

In order to achieve the objective of the present disclosure, a method for a node, which is positioned in a network including at least one shard based on regionally divided domains, to process a blockchain transaction in a distributed manner may comprises generating a dynamic committee including a plurality of nodes included in an identical shard; verifying a transaction through the generated committee and generating a transaction block; and storing the generated transaction block in a local ledger to which the node belongs.

The at least one shard may include at least one local shard including nodes regionally positioned within a certain range and a global shard including a plurality of nodes belonging to different local shards.

The method to process a blockchain transaction in a distributed manner may further comprise determining whether the node is a local node or a global node according to domain information in the network

Here, the generating of the dynamic committee including the plurality of nodes included in the identical shard may include generating a local committee or a global committee according to whether the node is a local node or a global node, respectively.

The generating of the dynamic committee including the plurality of nodes included in the identical shard may include generating a proof of work (PoW) block with reference to an initial epoch flag block; identifying nodes which have generated PoW blocks through communication with other nodes; broadcasting a committee contract and voting on committee members; and determining committee members according to vote results.

The method may further comprise, when the node is an initial leader of the committee, generating an epoch flag block for the committee.

The generated epoch flag block is referred to and used by a node, which is not a member of the committee, to generate a proof of work (PoW) block.

The committee contract may include a list of PoW block generating nodes and further include at least one of a sequence number, a hash value of an epoch flag block, a hash value of the PoW block, and a signature.

The storing of the generated transaction block in the local ledger to which the node belongs may include, when the node is a global node, storing the generated transaction block not in the global shard but in a local ledger of a local shard to which the global node belongs.

In order to achieve the objective of the present disclosure, an apparatus for a node, which is positioned in a network including at least one shard based on regionally divided domains, to process a blockchain transaction in a distributed manner comprises a local ledger configured to store at least one blockchain transaction block; a processor; and a memory configured to store at least one instruction executed by the processor, wherein the at least one instruction may include: an instruction to generate a dynamic committee including a plurality of nodes included in an identical shard; an instruction to verify a transaction through the generated committee and generate a transaction block; and an instruction to store the generated transaction block in the local ledger.

The at least one shard may include at least one local shard including nodes regionally positioned within a certain range and a global shard including a plurality of nodes belonging to different local shards.

The at least one instruction may further include an instruction to determine whether the node is a local node or a global node according to domain information in the network.

The instruction to generate the dynamic committee including the plurality of nodes included in the identical shard may include an instruction to generate a local committee or a global committee according to whether the node is a local node or a global node, respectively.

The instruction to generate the dynamic committee including the plurality of nodes included in the identical shard may include an instruction to generate a proof of work (PoW) block with reference to an initial epoch flag block; an instruction to identify nodes which have generated PoW blocks through communication with other nodes; an instruction to broadcast a committee contract and vote on committee members; and an instruction to determine committee members according to vote results.

The at least one instruction may further include an instruction to generate an epoch flag block for the committee when the node is an initial leader of the committee.

The generated epoch flag block is referred to and used by a node, which is not a member of the committee, to generate a proof of work (PoW) block.

The committee contract may include a list of PoW block generating nodes and further includes at least one of a sequence number, a hash value of an epoch flag block, a hash value of a PoW block, and a signature.

The instruction to store the generated transaction block in the local ledger may include an instruction to store the generated transaction block not in the global shard but in a local ledger of a local shard to which the global node belongs when the node is a global node.

The at least one blockchain transaction block stored in the local ledger may include at least one of transaction blocks resulting from a global transaction associated with interoperation between local shards and a transaction within an identical local shard.

### BRIEF DESCRIPTION OF DRAWINGS

Example embodiments of the present invention will become more apparent by describing in detail example embodiments of the present invention with reference to the accompanying drawings, in which:

FIG. 1 is a diagram showing a brief configuration of a blockchain to which an example embodiment of the present invention is applied;

FIG. 2 is a conceptual diagram of a blockchain system for providing domain based sharding according to an example embodiment of the present invention;

FIG. 3 is a conceptual diagram of a global shard and local committees according to an example embodiment of the present invention;

FIG. 4 is a conceptual diagram of a constitution of a committee according to an example embodiment of the present invention;

FIG. 5 shows a constitution example of a committee according to an example embodiment of the present invention;

FIG. 6 is a flowchart illustrating a method of forming a dynamic committee according to an example embodiment of the present invention;

FIG. 7 is a conceptual diagram of local transaction processing according to an example embodiment of the present invention;

FIG. 8 is a conceptual diagram of global transaction processing according to an example embodiment of the present invention; and

FIG. 9 is a block diagram of an apparatus for processing a blockchain transaction in a distributed manner according to an example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, and example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

Hereinafter, exemplary embodiments of the present invention will be described in detail with reference to the accompanying drawings.

Hereinafter, exemplary embodiments of the present invention will be described in detail with reference to the accompanying drawings.

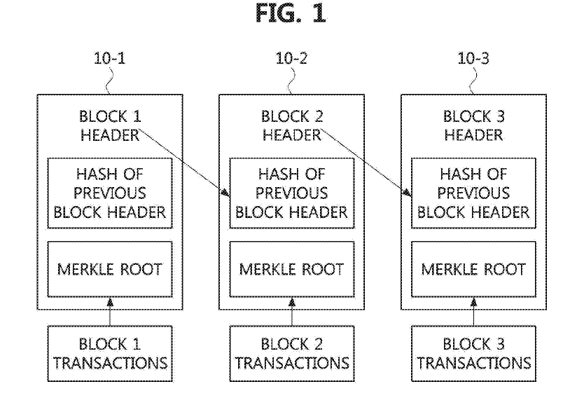

FIG. 1 is a diagram showing a brief configuration of a blockchain to which an example embodiment of the present invention is applied.

Blockchain is a technology designed to prevent hacking, which may occur when a transaction is made with a cryptocurrency, and is also referred to as a public transaction ledger. While transaction records are stored in a central server according to the related art, a blockchain shows transaction records to all users and compares the records to prevent fraud.

In a blockchain, each block is a record for storing and approving numerous transactions on standby. On average, about every 10 minutes a new block including transactions is added to a blockchain through mining. Mining is a process in which computer hardware performs mathematical computations for transaction approval and security enhancement in the Bitcoin network. As reward for the service, Bitcoin miners receive transaction fees of transactions that the miners approve and newly generated Bitcoins. In the Bitcoin mining market, rewards are distributed depending on how much computation has been performed by each miner.

A block is a kind of data packet, which contains some kind of information and is composed of a header and a body. A block header may include a version of a current Bitcoin program, a hash value of a previous block, a hash value of all transaction information of the current block, a timestamp of the current block, the degree of difficulty (a target hash value), and a nonce value. A body of a block includes details of all transfers included in the block.

A blockchain may be based on a Merkle tree structure. A Merkle tree is also referred to as a hash tree and is a kind of tree structure in which leaf nodes indicate data, such as files, and names of all non-leaf nodes are composed of hashes of child nodes. A Merkle tree is frequently used to verify validity of data sent from a peer-to-peer (P2P) system and the like.

Referring to FIG. 1, in a blockchain, headers 10-1, 10-2, and 10-3 of respective blocks include Merkle roots associated with a series of transactions and thus include hash values of previous block headers. Here, a transaction identity (ID) is composed of a hash value of a transaction, and a Merkle tree is composed of such hash values.

As described above, all transaction information, which has been propagated to users before a block is found, is recorded in the block of a blockchain and transmitted to all the users in a P2P fashion. Therefore, it is not possible to arbitrarily modify or omit transaction information.

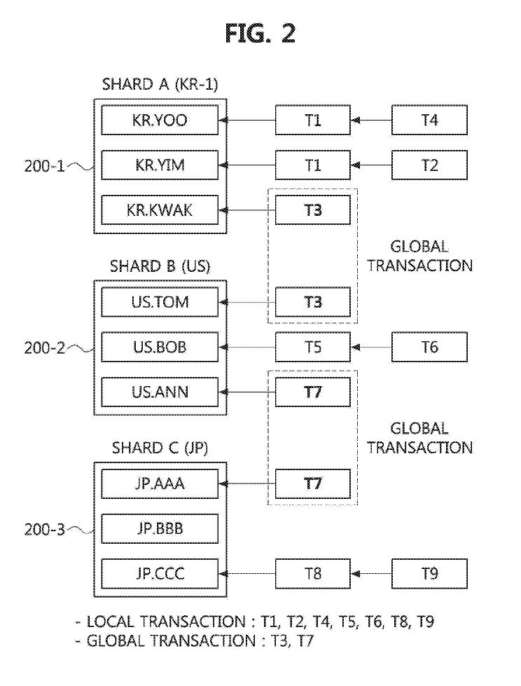

FIG. 2 is a conceptual diagram of a blockchain system for providing domain-based sharding according to an example embodiment of the present invention.

The present invention provides a blockchain system for providing domain-based sharding for distributed transaction processing, and FIG. 2 shows a concept of a blockchain system for providing domain-based sharding according to an example embodiment of the present invention.

A blockchain stores transactions in a distributed manner on the basis of a P2P network. Here, when the transactions increase, individual nodes are limited in transaction processing rate as well as storage capacity. Sharding, which has been suggested to process a large amount of data of a blockchain, involves partitioning data in a database and storing the partitioned data in a distributed manner, thereby ensuring expandability. Sharding makes it possible to simultaneously generate and manage as many blocks as shards and to keep a size of a blockchain small, depending on the shard.

A whole network according to an example embodiment of the present invention is composed of shards which are regionally divided. For example, it is possible to classify shards according to regions, such as Korea, North America, Europe, and Japan, and provide service depending on the shard. Referring to the example embodiment of FIG. 2, the network shown in FIG. 2 may include shard A for the Korean area, shard B for the US area, and shard C for the Japanese area.

For example, in the case of an account transfer service, since the number of transactions for remittance within Korea is far greater than the number of transactions for remittance to foreign countries, transactions occurring in the same shard may be processed in the shard to improve performance of the account transfer service according to the present invention. Also, a transaction that requires interoperation between the shards is defined as a global transaction and is processed in a global shard.

Referring to FIG. 2, T1, T2, T4, T5, T6, T8, and T9 are shard-specific local transactions, and T3 and T7 may be classified as global transactions. T3 is a global transaction from shard A to shard B, and T7 is a global transaction between shard B and shard C. T1, T2, and T4 which are transactions within Korean may be processed in shard A, T5 and T6 which are transactions within US may be processed in shard B, and T8 and T9 which are transactions within Japan may be processed in shard C. Also, T3 and T7 which are global transactions may be processed in the global shard which is separately defined.

In the present invention, shards are divided on the basis of domains, and accounts are managed on the basis of the domains, and therefore it may be determined which transaction is processed by which shard. Each domain is managed by an individual shard, and shard-specific accounts are identified on the basis of the domains. Therefore, a local transaction is processed by a corresponding local shard, and a global transaction is processed in the global shard.

Referring to FIG. 2, domain-based shards include shard A 200-1 of KR domain, shard B 200-2 of US domain, and shard C 200-3 of JP domain. In each shard, an account may have a domain as a prefix. For example, accounts of shard A may be configured in the form of “kr.aaa” for identification.

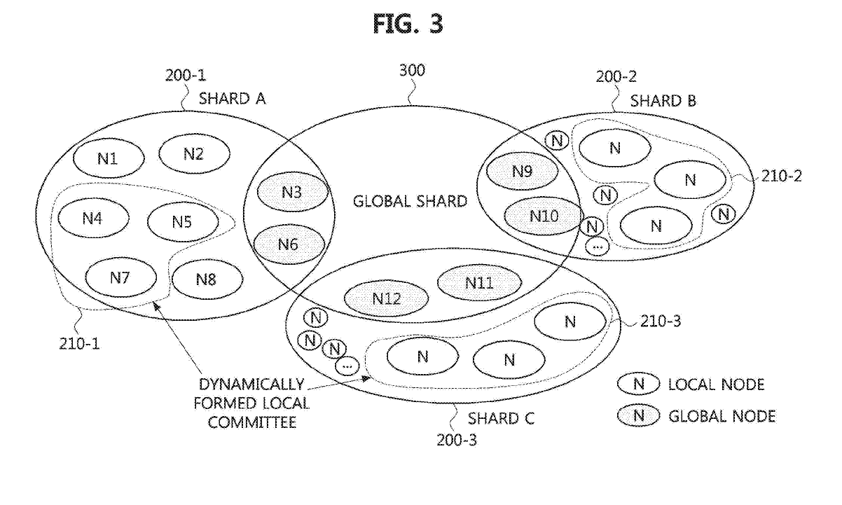

FIG. 3 is a conceptual diagram of a global shard and local committees according to an example embodiment of the present invention.

Referring to FIG. 3, multiple nodes n1, n2, . . . in a network belong to shards which are regionally divided.

A local node verifies location transactions in a local shard to which the node belongs, and a global node verifies global transactions. Therefore, one node may be a local node or a global node. Also, local nodes according to an example embodiment of the present invention may belong to local committees 210-1, 210-2, and 210-3 which are dynamically formed. In a shard, local nodes and global nodes may be appropriately distributed, and each node in a shard may select which one of a local node and a global node it will be by referring to domain information in the P2P network.

Here, each node communicates with other nodes in a P2P fashion. Each node may be any device capable of computing and may be a device such as a personal computer (PC), a laptop, a cellular phone, a tablet PC, a smart phone, etc. which are capable of accessing the network in a wired or wireless manner.

A local transaction is verified by a local committee which is dynamically formed in a corresponding shard such that transaction blocks are generated and stored in local ledgers of the shard. A global transaction is verified by a global shard 300, and the verification result is transferred to a local shard associated with the transaction. The verification result is generated as a block by the local shard and stored in each local ledger.

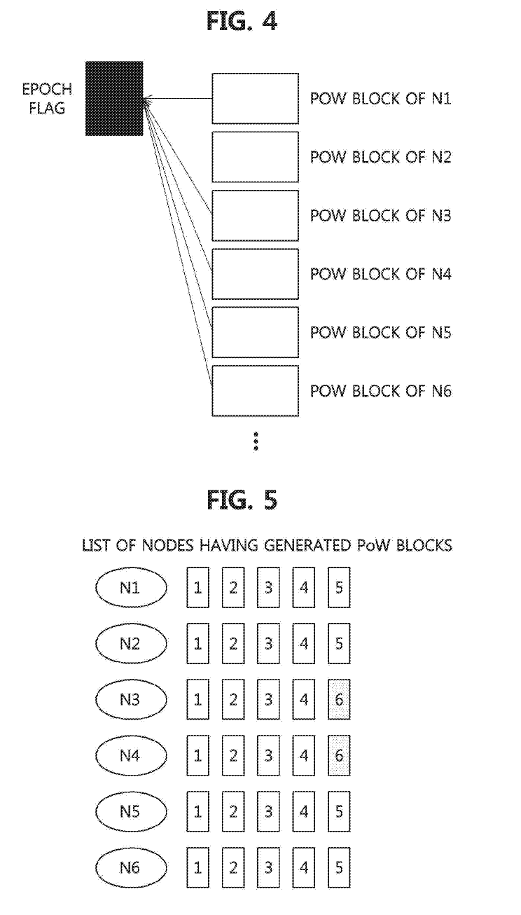

FIG. 4 is a conceptual diagram of a constitution of a committee according to an example embodiment of the present invention.

In the present invention, a committee denotes a dynamic group for transaction processing and may include at least one node. In the present invention, it is possible to dynamically configure a committee by selecting qualified nodes from among nodes of a corresponding shard through a proof of work (PoW) process. Here, PoW is a piece of data for verifying that nodes trying to generate PoW blocks have performed works with a specific degree of difficulty by calculating a specific hash value.

As described above, in the present invention, qualified nodes are selected from among nodes of a corresponding shard through a PoW process and dynamically constitute a committee. To form a committee, a consensus regarding node selection is required. In an example embodiment of the present invention, M nodes which have generated PoW blocks are selected with reference to an epoch flag block and constitute a committee. Here, M may denote the number of committee members.

Meanwhile, each node which has generated a PoW block notifies other nodes in the shard that the node has generated a PoW block. Respective nodes may have different lists of nodes which have generated the PoW blocks. In other words, a list of nodes which have generated the PoW blocks may vary depending on the view of each node. Therefore, the respective nodes separately broadcast M lists of nodes which have generated the PoW blocks to other nodes in the shard and constitute a committee with a consensus of 2/3 or more in a vote on a committee member constitution.

To this end, a node which has generated the PoW block broadcasts a committee contract for the vote on committee members to the network and reaches a consensus about a committee member constitution with nodes which participate in the vote through several rounds.

The committee contract may include a sequence number, an epoch flag block hash, a list of PoW block generation nodes, a PoW block hash, and a signature. The sequence number is a value which sequentially increases from zero. The sequence number sequentially increases according to a round until a corresponding committee is formed with a consensus of a certain ratio or more, for example, 2/3, of nodes participating in the vote.

The epoch flag block hash is a hash value of an epoch flag block on which a PoW is based. The list of PoW block generation nodes is a list of nodes which are determined to have generated the PoW blocks by a corresponding node from the view of the corresponding node, and the PoW block hash is a hash value of a generated PoW block.

FIG. 5 shows a constitution example of a committee according to an example embodiment of the present invention.

FIG. 5 shows a case as an example in which 5 nodes having generated PoW blocks are selected as committee members. In FIG. 5, nodes n1, n2, n5, and n6 have a node list of 1, 2, 3, 4, and 5, and nodes n3 and n4 have a node list of 1, 2, 3, 4, and 6. The nodes n1 to n5 vote on a list of 5 nodes, and a committee is formed of the nodes n1, n2, n5, and n6 having a node list of 1, 2, 3, 4, and 5.

An epoch flag block is a reference point at which one committee starts. A committee is formed of nodes which have generated PoW blocks earlier than the epoch flag block. When a committee is formed, it is possible to generate several blocks without a process of changing committee members until a next epoch flag block is generated. Therefore, a committee may contribute performance improvement.

When a committee is formed, a list of committee members is broadcast so that other nodes in a shard may be notified of the list. In this way, members of an immediately preceding committee are excluded from the vote on a next committee member constitution so that member nodes of a committee may not simultaneously participate in transaction verification and PoW block generation.

Both a local committee and a global committee are dynamically formed through a process of selecting members from among nodes in a corresponding shard, and the committees are reformed after N blocks are generated.

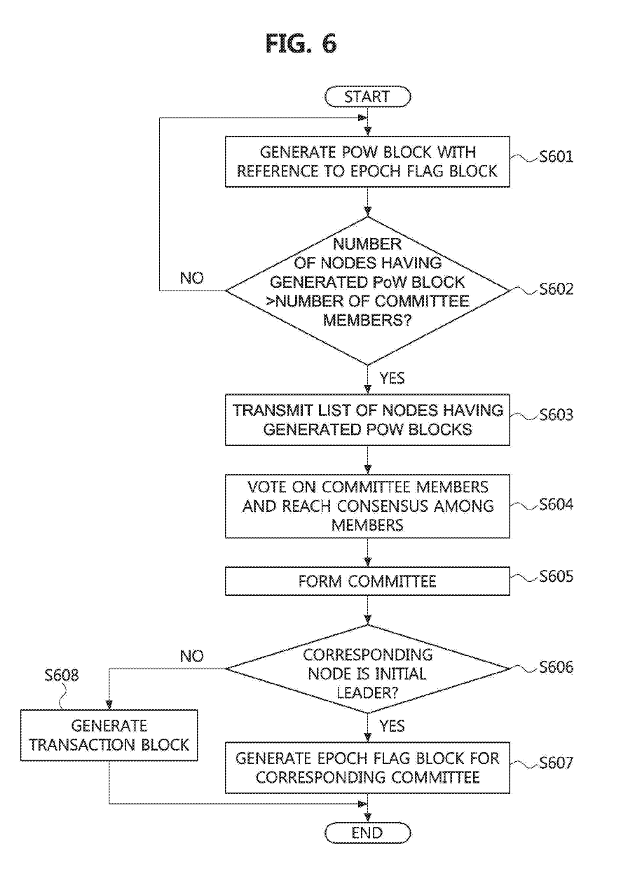

FIG. 6 is a flowchart illustrating a method of forming a dynamic committee according to an example embodiment of the present invention.

A subject of dynamic committee formation shown in FIG. 6 may be a node included in a distributed processing system or network according to an example embodiment of the present invention. As described above, the distributed processing network according to an example embodiment of the present invention may include shards which are regionally divided.

First, nodes in a shard generate PoW blocks with reference to a specific epoch flag block (S601). Here, the epoch block may be a block associated with a committee which has been formed already on the basis of a previous epoch or may be initially set for committee formation when there is no previous epoch.

Each node identifies the number of nodes which have generated PoW blocks through P2P communication with other nodes and determines whether the number of nodes having generated PoW blocks is greater than the number of committee members (S602). When the number of nodes having generated PoW blocks is greater than the number of committee members, each node transmits a list of nodes, which have generated PoW blocks, identified through communication with other nodes to the other nodes in the shard (S603). In the example of FIG. 5, the node n1 transmit a node list of 1, 2, 3, 4, and 5.

The vote on a committee member constitution may be performed, and a committee may be formed of candidate members upon which a consensus is made as vote results among members exceeding a reference value or more, for example, 2/3, of the total number of members (S604 and S605). Here, a subject which makes progress in the vote and determines whether a consensus is made may be any one of nodes which apply for the committee. For example, the subject may be a leader member.

When the committee is formed, each node determines whether the node itself is an initial leader of the committee (S606). When a corresponding node is the initial leader of the committee, the node generates an epoch flag block (S607). When a node is a member other than a leader, the node generates a transaction block (S608). After transaction blocks are sequentially generated, the corresponding epoch ends.

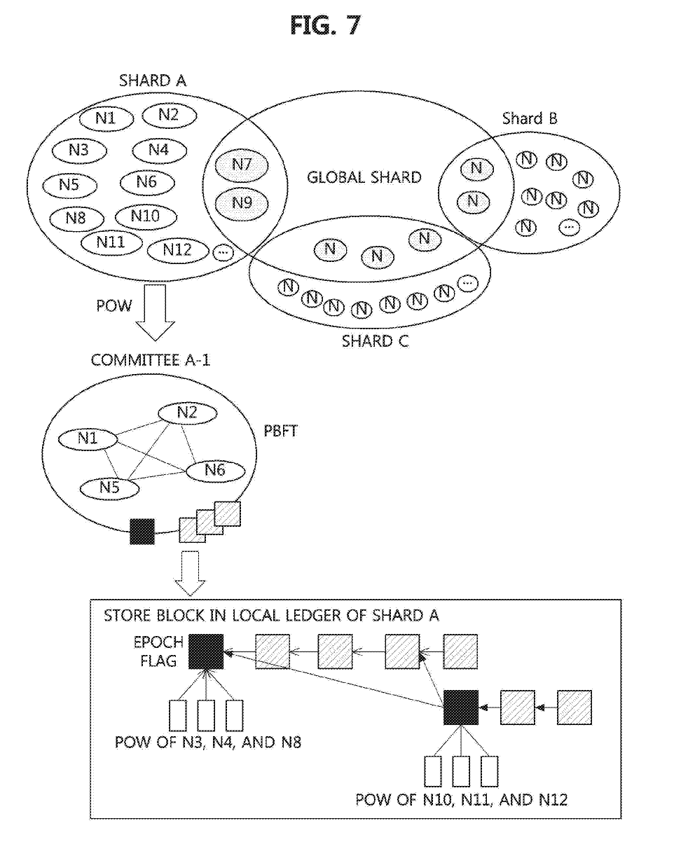

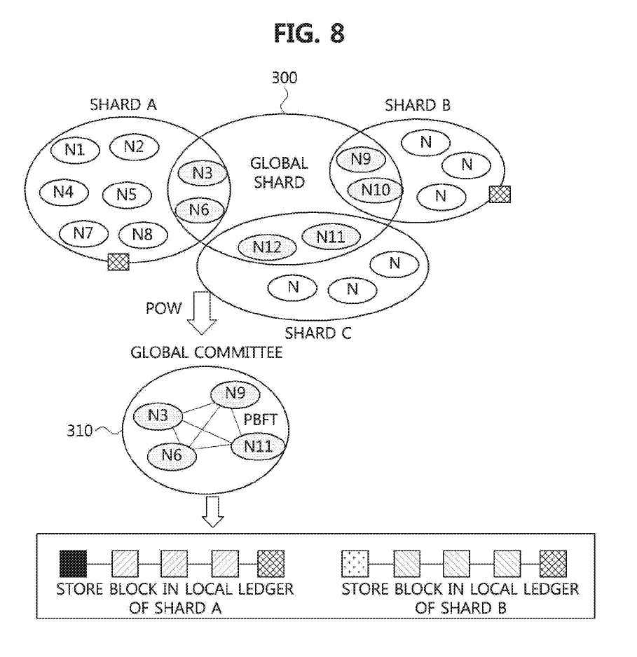

FIG. 7 is a conceptual diagram of local transaction processing according to an example embodiment of the present invention.

According to an example embodiment of the present invention, a local transaction is generated as transaction blocks by a local committee, which is dynamically formed in a corresponding shard, and stored in local ledgers of the shard.

FIG. 7 illustrates a process of local transaction processing by taking a local transaction of shard A as an example. As described above, a committee is formed of nodes which are selected through PoW blocks from among local nodes of shard A.

Referring to FIG. 7, committee A-1 is formed of nodes n1, n2, n5, and n6. When the committee is formed, a leader generates an epoch flag block to announce the start of the committee, and the committee members verify a local transaction through practical byzantine fault tolerance (PBFT) consensus and generate transaction blocs. Nodes other than the committee members may prepare themselves to form a next committee by generating PoW blocks with reference to the epoch flag block.

In the example of shard A shown in FIG. 7, nodes n3, n4, and n8 generate PoW blocks with reference to a first epoch flag block. Subsequently, nodes n10, n11, and n12 generate PoW blocks with reference to a second epoch flag block which is based on the first epoch block. Also, in shard B, nodes generate PoW blocks with reference to a first epoch flag block of shard B, and operations of shard A and shard B may simultaneously occur in parallel.

Round-robin scheduling is used to select a committee leader so that different leaders may be determined in sequence. Therefore, after a first leader of an epoch generates an epoch flag block, other leaders sequentially generate transaction blocks. Here, the generated blocks are propagated to nodes in a corresponding shard and stored in local ledgers such that local ledgers are maintained depending on the shard.

As described above, according to an example embodiment of the present invention, committee member nodes in a plurality of shards verify transactions and generate blocks, and nodes other than committee members prepare themselves to form committees by generating PoW blocks. Therefore, it is possible to reduce transaction processing time and committee formation time.

FIG. 8 is a conceptual diagram of global transaction processing according to an example embodiment of the present invention.

A global transaction according to an example embodiment of the present invention is verified in a global shard, and then the verification result is transferred to associated local shards. The verification result is generated as a block in the corresponding local shards and stored in each local ledger.

In FIG. 8, the process of transaction processing is illustrated by taking a global transaction from shard A to shard B as an example. In the example of FIG. 8, a global shard 300 includes global nodes n3, n6, n9, n10, n11, n12, and the like. A global committee 310 is formed of global nodes through PoW, and the global committee 310 of FIG. 8 is formed of the nodes n3 and n6 of shard A, the node n9 of shard B, and the node n11 of shard C.

The global committee members verify a global transaction through PBFT consensus and transfer the verification result to shard A and shard B. In each of shard A and shard B, blocks for the global transaction are generated and stored in a corresponding local ledger.

According to the related art, distributed nodes collect and verify transactions, generate blocks, and store a whole block chain. Therefore, when a large amount of data is simultaneously processed, a transmission delay occurs in a network, which thus increases the processing cost.

However, according to an example embodiment of the present invention, regionally divided shards are organized, and thus it is possible to simultaneously generate and manage blocks depending on the shard. Also, since the constitution of a committee for verifying blocks in the shard is dynamically changed, high security is provided.

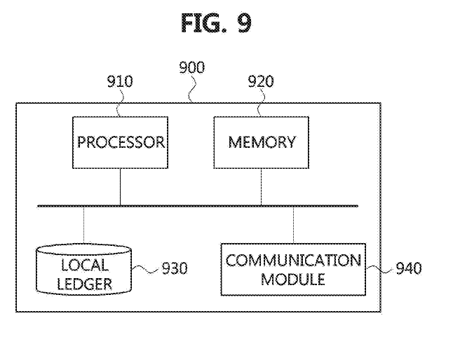

FIG. 9 is a block diagram of an apparatus for processing a blockchain transaction in a distributed manner according to an example embodiment of the present invention.

An apparatus for processing a blockchain transaction in a distributed manner according to an example embodiment of the present invention may be each node in the above-described example embodiments. Here, each node communicates with other nodes in a P2P fashion. Each node may be any device capable of computing and may be a device such as a PC, a laptop, a cellular phone, a tablet PC, a smart phone, etc. which are capable of accessing a network in a wired or wireless manner.

Referring to FIG. 9, as an apparatus 900 for processing a blockchain transaction in a distributed manner processes, a node in a network including at least one shard based on domains which are regionally divided. To this end, the apparatus 900 may include a processor 910, a memory 920 configured to store at least one instruction executed by the processor 910, and a local ledger 930 configured to store at least one blockchain transaction block.

The at least one instruction may include an instruction to generate a dynamic committee including a plurality of nodes included in the same shard, an instruction to verify a transaction and generate a transaction block through the generated committee, and an instruction to store the generated transaction block in the local ledger 930.

Additionally, the apparatus 900 for processing a blockchain transaction in a distributed manner may include a communication module 940 configured to communicate with other nodes. The communication module 940 may communicate with other nodes using various wired and wireless communication methods supporting P2P communication.

According to the above-described example embodiments of the present invention, the shards are organized on the basis of domains, which are regionally divided, to simultaneously verify a transaction and generate and manage blocks depending on the shard. Therefore, a large amount of data may be rapidly processed in an Internet of things (IoT) environment.

Accordingly, the present invention may improve the processing performance of a system for processing a blockchain in a distributed manner and ensure expandability thereof.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the example embodiments of the present invention and their advantages have been described in detail, it should be understood that various changes, substitutions and alterations may be made herein without departing from the scope of the invention.

What is claimed is:

1. A method for a node, which is positioned in a network including at least one shard based on regionally divided domains, to process a blockchain transaction in a distributed manner, the method comprising:
generating a dynamic committee including a plurality of nodes included in an identical shard;
verifying a transaction through the generated committee and generating a transaction block; and
storing the generated transaction block in a local ledger to which the node belongs.

2. The method of claim 1, wherein the at least one shard includes:
at least one local shard including nodes regionally positioned within a certain range; and
a global shard including a plurality of nodes belonging to different local shards.

3. The method of claim 2, further comprising determining whether the node is a local node or a global node according to domain information in the network.

4. The method of claim 3, wherein the generating of the dynamic committee including the plurality of nodes included in the identical shard includes generating a local committee or a global committee according to whether the node is a local node or a global node, respectively.

5. The method of claim 1, wherein the generating of the dynamic committee including the plurality of nodes included in the identical shard includes:
generating a proof of work (PoW) block with reference to an initial epoch flag block;
identifying nodes which have generated PoW blocks through communication with other nodes;
broadcasting a committee contract and voting on committee members; and
determining committee members according to vote results.

6. The method of claim 1, further comprising, when the node is an initial leader of the committee, generating an epoch flag block for the committee.

7. The method of claim 6, wherein the generated epoch flag block is referred to and used by a node, which is not a member of the committee, to generate a proof of work (PoW) block.

8. The method of claim 5, wherein the committee contract includes a list of PoW block generating nodes and further includes at least one of a sequence number, a hash value of an epoch flag block, a hash value of the PoW block, and a signature.

9. The method of claim 1, wherein the storing of the generated transaction block in the local ledger to which the node belongs includes, when the node is a global node, storing the generated transaction block not in the global shard but in a local ledger of a local shard to which the global node belongs.

10. An apparatus for a node, which is positioned in a network including at least one shard based on regionally divided domains, to process a blockchain transaction in a distributed manner, the apparatus comprising:
a local ledger configured to store at least one blockchain transaction block;
a processor; and
a memory configured to store at least one instruction executed by the processor,
wherein the at least one instruction includes:
an instruction to generate a dynamic committee including a plurality of nodes included in an identical shard;
an instruction to verify a transaction through the generated committee and generate a transaction block; and
an instruction to store the generated transaction block in the local ledger.

11. The apparatus of claim 10, wherein the at least one shard includes:
at least one local shard including nodes regionally positioned within a certain range; and
a global shard including a plurality of nodes belonging to different local shards.

12. The apparatus of claim 11, wherein the at least one instruction further includes an instruction to determine whether the node is a local node or a global node according to domain information in the network.

13. The apparatus of claim 12, wherein the instruction to generate the dynamic committee including the plurality of nodes included in the identical shard includes an instruction to generate a local committee or a global committee according to whether the node is a local node or a global node, respectively.

14. The apparatus of claim 10, wherein the instruction to generate the dynamic committee including the plurality of nodes included in the identical shard includes:
an instruction to generate a proof of work (PoW) block with reference to an initial epoch flag block;
an instruction to identify nodes which have generated PoW blocks through communication with other nodes;
an instruction to broadcast a committee contract and vote on committee members; and
an instruction to determine committee members according to vote results.

15. The apparatus of claim 10, wherein the at least one instruction further includes an instruction to generate an epoch flag block for the committee when the node is an initial leader of the committee.

16. The apparatus of claim 15, wherein the generated epoch flag block is referred to and used by a node, which is not a member of the committee, to generate a proof of work (PoW) block.

17. The apparatus of claim 14, wherein the committee contract includes a list of PoW block generating nodes and further includes at least one of a sequence number, a hash value of an epoch flag block, a hash value of a PoW block, and a signature.

18. The apparatus of claim 10, wherein the instruction to store the generated transaction block in the local ledger includes an instruction to store the generated transaction block not in the global shard but in a local ledger of a local shard to which the global node belongs when the node is a global node.

19. The apparatus of claim 10, wherein the at least one blockchain transaction block stored in the local ledger includes at least one of transaction blocks resulting from a global transaction associated with interoperation between local shards and a transaction within an identical local shard.
